(19) United States
(12) Patent Application Publication
(10) Pub. No.: US 2006/0012985 A1
(43) Pub. Date: Jan. 19, 2006

(54) Flat panel lighting for enclosed space illumination

(75) Inventors: William C. Archie JR., Pittsford, NY (US); Giana M. Phelan, Rochester, NY (US); David R. Strip, Albuquerque, NM (US); James G. Stephens, Pittsford, NY (US); Ronald S. Cok, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/892,861

(22) Filed: Jul. 15, 2004

(51) Int. Cl. B60Q 1/26

(52) U.S. Cl. 362/227

(57) ABSTRACT

An illuminated storage system is disclosed comprising one or more rigid surfaces defining an enclosed volume; two or more conductors attached to one or more of the rigid surfaces; one or more solid-state flat panel area illumination light sources, each light source having electrical contacts; and means for making contact between a pair of the conductors attached to the rigid surfaces and the electrical contacts of the flat-panel light sources. The use of solid-state flat panel area illumination light sources enables high-quality diffuse light to be provided over a large area by a light source that is quite thin in cross-section, and that can be supplied in a form that is compatible with standard household current.

### FIELD OF THE INVENTION

This invention pertains to the field of flat-panel light emitting devices and more specifically to the incorporation of flat-panel lights into cabinets and enclosed storage for interior, exterior, and decorative illumination.

### BACKGROUND OF THE INVENTION

Homes, offices, workshops, and stores are furnished with cabinetry (also referred to as casework in the architectural trade). There are currently very few space- and cost-effective options for illuminating the interior of cabinets. Conventional Edison-base incandescent bulbs (the familiar 60-100 watt light bulbs that fill our homes) are generally too bulky for convenient placement inside a cabinet. In addition, safety considerations would dictate that these bulbs be surrounded by some sort of protective enclosure, further increasing the volume they occupy. Smaller incandescent lamps, such as the MR-16 halogen bulbs introduce a different set of challenges. These bulbs tend to have focused output, inappropriate to the confined space of a cabinet. They operate on a 12V supply, which necessitates the addition of a step-down transformer that takes additional space, wastes power, and generates heat. The bulbs themselves burn quite hot and will require extra protection to prevent burns as well as ignition of items inside the cabinet. Fluorescent lamps are an improvement over incandescents in many respects, but have problems of their own. Fluorescent lamps provide more diffuse light than most incandescent bulbs, but also tend to take up more space. They run cooler than incandescent lamps, but are still uncomfortable to touch. They may still require diffusers or other protection in cabinets that may contain combustible materials that could contact the lamps. The small bulbs that would be required to fit inside a cabinet are hard to find, expensive, and available in a limited range of color rendering indices and color temperatures, leading to consumer dissatisfaction in the quality of illumination and appearance of items inside the cabinet. Moreover, light bulbs are relatively fragile and may explode if damaged. LEDs have been suggested as a lighting option for cabinetry, but these have their own shortcomings. The major problem with LEDs is that they are fabricated as small point sources. Therefore, a string of small lamps needs to be strung inside the cabinet to provide any semblance of uniform illumination. LEDs are low voltage devices, so once again the user is faced with a step-down transformer and its associated problems. Although LEDs tend to be quite reliable, their most common failure mode is an open circuit, which precludes wiring individual lights in series to match standard household voltage supplies.

This catalog of shortcomings clearly shows that there is a need for an improved means of lighting cabinet interiors.

### SUMMARY OF THE INVENTION

According to one embodiment, the present invention is directed towards an illuminated storage system comprising one or more rigid surfaces defining an enclosed volume; two or more conductors attached to one or more of the rigid surfaces; one or more solid-state flat panel area illumination light sources, each light source having electrical contacts; and means for making contact between a pair of the conductors attached to the rigid surfaces and the electrical contacts of the flat-panel light sources. The use of solid-state flat panel area illumination light sources in accordance with the present invention enables high-quality diffuse light to be provided over a large area by a light source that is quite thin in cross-section, and that can be supplied in a form that is compatible with standard household current.

### BRIEF DESCRIPTION OF THE DRAWINGS

FIG. 1 is a prior-art cross-sectional view of a basic OLED device.

FIG. 2 is a perspective view of a cabinet containing a flat-panel light source attached to a shelf according to an embodiment of the present invention;

FIG. 3 is a perspective view of a cabinet containing a flat-panel light source which additionally functions as a shelf according to an alternative embodiment of the present invention;

FIG. 4 is a detailed view of a system for accommodating movable shelves according to an embodiment of the present invention;

FIG. 5 is an exploded cross-section of a wired cabinet system according to an embodiment of the present invention;

FIG. 6 is an exploded cross-section of cabinet-to-cabinet electrical connection according to an embodiment of the present invention; and

FIG. 7 is perspective view of cabinet containing flat-panel light sources according to an alternative embodiment of the present invention.

### DETAILED DESCRIPTION OF THE INVENTION

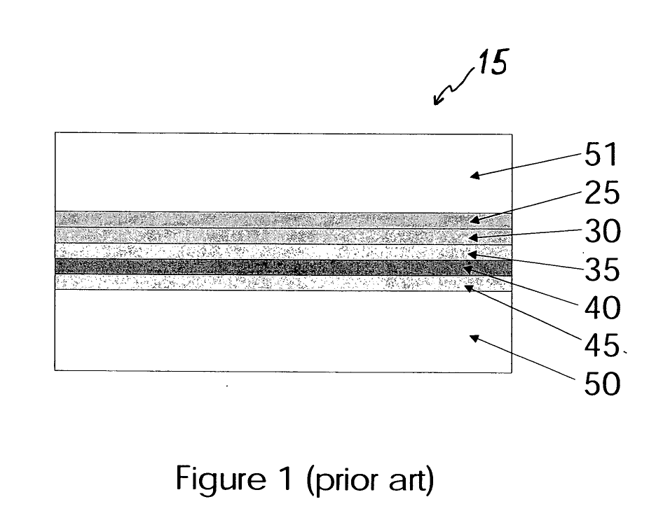

FIG. 1 illustrates the basic structure of a flat panel light source 15 formed using organic light-emitting diode (OLED) technology. A series of thin-film layers (˜50 nm) are deposited on a substrate 50, typically glass. These layers are a cathode 25, an electron injection layer 30, an emitter layer 35, a hole injection layer 40, and an anode 45. Electrical current is applied to the anode and cathode. The current flows in the form of holes from the anode and electrons in the cathode. The holes and electrons meet and recombine in the emitter layer to emit a photon light. In practice, the entire light source 15 is encapsulated by means of a cover 51, typically comprising glass, which is sealed (not shown) to the substrate 50 at the edges. The encapsulation provides protection for the light forming layers from environmental factors such as oxygen, moisture, and the like.

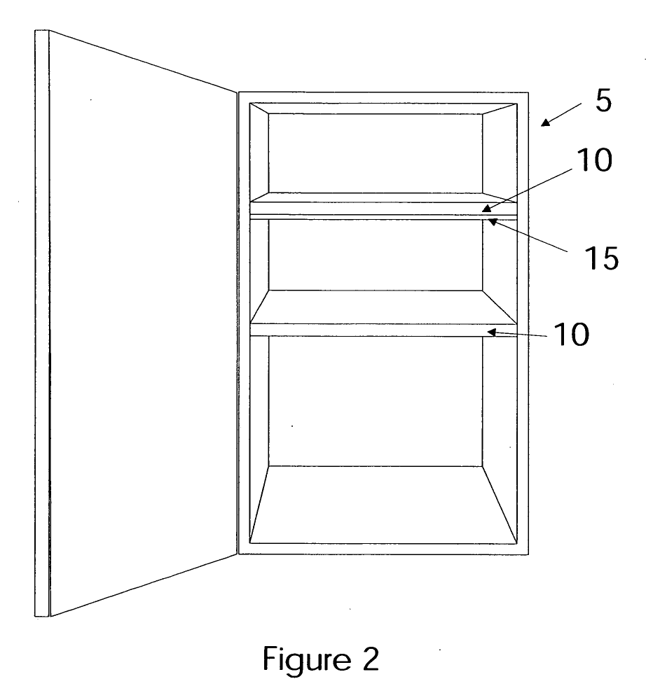

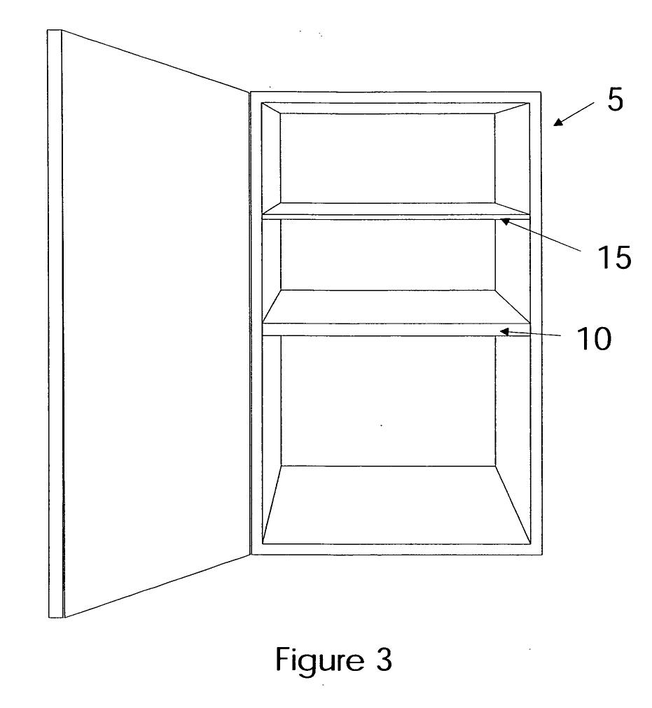

Referring to FIG. 2, a cabinet 5 is shown containing two shelves 10. A flat-panel light source 15 is removably affixed to one shelf. In this configuration, an OLED light source would be fabricated such that it emits all the light from the side opposite the shelf to which it is affixed. FIG. 3 shows an alternative configuration in which the flat panel light source 15 functions as both a shelf as well as a light source. In this case it may be desirable to use an OLED light source configured to emit light from both surfaces. When the OLED light source serves as the shelf, it may be desirable to laminate the OLED substrate and/or cover to a more robust material such as tempered glass, plastic sheeting, or plastic film. Many such laminating processes are familiar to one of ordinary skill in the art. Alternatively, the OLED light source may be constructed upon a thick, glass substrate providing adequate strength for supporting goods. For example, a substrate having a thickness of 5 mm or greater, more preferably 10 mm or greater, may serve both as a shelf and as a substrate for the flat-panel light source. In embodiments where the light source serves as the shelf, the glass cover 51 also provides protection to the light source from items placed upon the shelf. The flat-panel light sources may cover only a portion of the shelf surface, if desired. The invention may be practiced with cabinets having any number of shelves, where all of the shelves, or only some of the shelves, are provided with light sources.

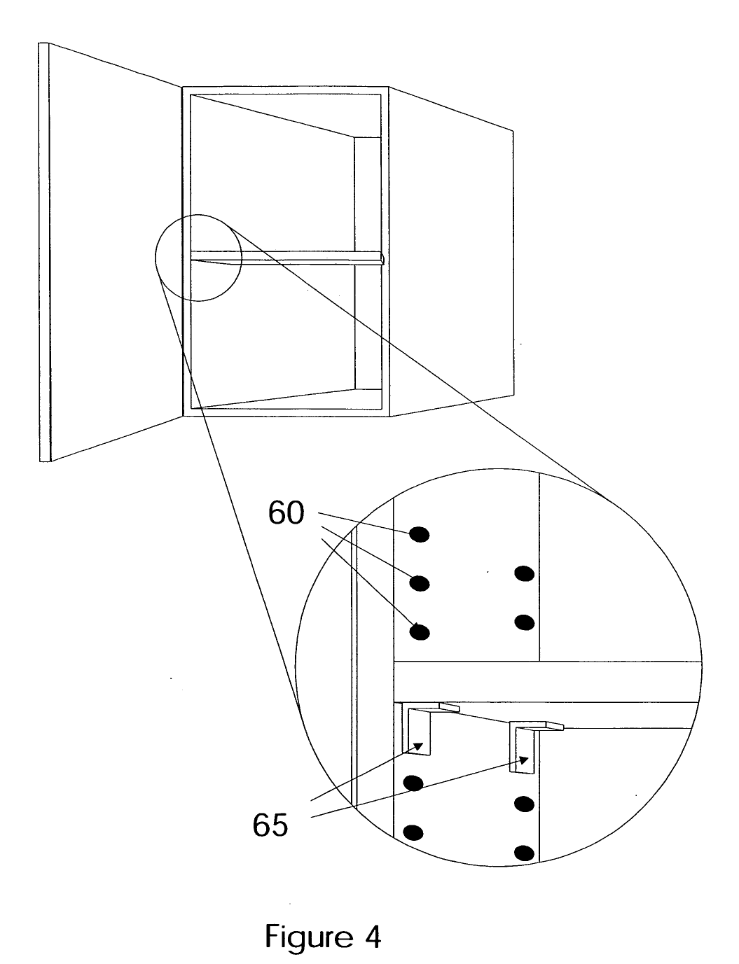

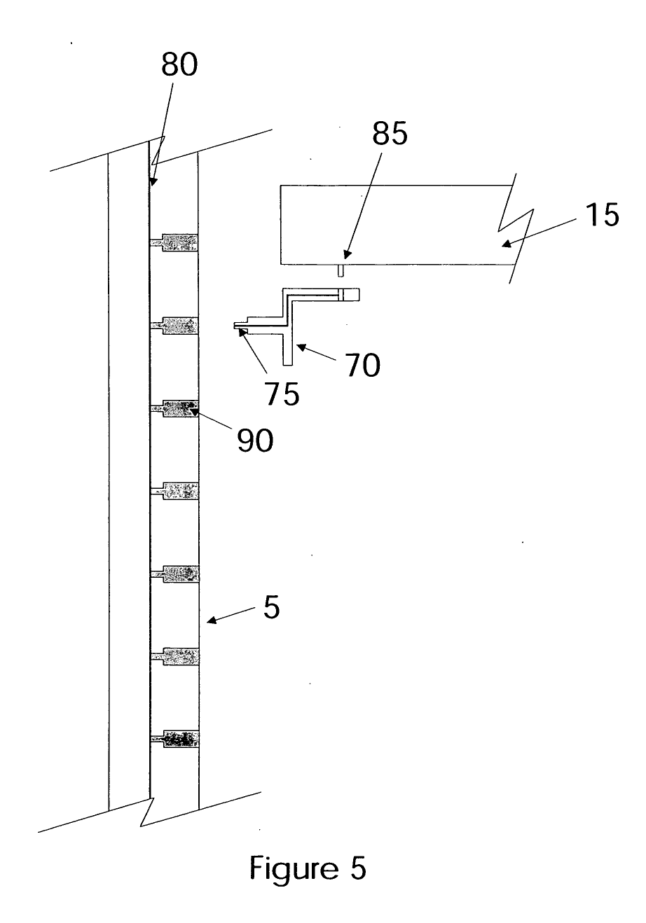

Many cabinet systems incorporate a means for easily repositioning shelves within the cabinet, as well as adding or subtracting shelves. One particularly common approach is shown in FIG. 4. In utilizing this approach, a plurality of holes 60 are drilled in the cabinet sides at regular intervals. These holes are typically 5 mm in diameter on 32 mm centers in metric cabinetry, ¼″ diameter on 1″ centers in English-measured casework. A shelf support 65 is inserted in each hole at the desired shelf level to provide support for the shelf. These brackets can take the form shown in this figure. They can be a simple pin, or take one of a number of other forms well known to one of ordinary skill in the art. FIG. 5 demonstrates a system that allows the simple repositioning of lighted shelves. The cabinet 5 contains a pair of conductors 80 (one visible in cross section) which are connected to household power (not shown), and means are provided for making contact between the conductors attached to the rigid surfaces of the cabinet and electrical contact 85 of the flat-panel light source 15. Each conductor is connected, e.g., to a plurality of energized holes 90 which hold shelf support 70 as well as provide electrical power to the contact. The energized shelf support 70 is similar to the shelf support 65, but in addition provides a support contact 75 that connects electrically to the energized hole.

If the cabinet 5 is left in an energized state at the time a user desires to rearrange or replace the lighted shelves, then means to prevent possible electrical shock is needed. In order to prevent shock, shelf support 70 may be constructed so that it may be handled by a user in a way that prevents the user from making contact with the electrical support contact 75 or any part of the support 70 that is electrically conducting. This may be accomplished by constructing the support 70 from a rigid plastic material similar to that employed in the construction of an ordinary electrical plug. Alternatively, the support 70 may be constructed of metal as long as an insulating cladding is provided.

As shown in FIG. 5, the flat-panel light source 15 may contain a shelf contact 85 that makes electrical contact directly with an energized shelf support 70. In the configuration shown, one column of holes provides contact to one leg of the electrical system and a second column of holes provides contact to the second leg of the electrical system. In an alternative to making direct contact between the conductors 80 connected to household power and the electrical contacts of a flat-panel light source through an energized shelf support, the means for making contact may include an intermediate socket. A removable shelf may contain an electrical contact suitable for connection to the energized shelf support, e.g., and the shelf in turn contains contacts for connection to a flat-panel light source, and function as a socket such as described in US2003/0222558, the disclosure of which is incorporated herein by reference in its entirety. The shelf system described may be assembled by first inserting the pins into the holes and, secondly, by laying the shelf upon the pins to complete the circuit.

Similar systems providing both electrical contacts through a single energized hole/energized shelf support or through two supports on the same end of a shelf or using supports provided at the back of the shelf may be constructed in accordance with the invention. Further, energy may be provided to a flat-panel light source through contacts that are distinct from the support holes. In such embodiments, means for making contact between the conductors attached to the rigid surfaces and the electrical contacts of the flat-panel light sources may include discrete contacts designed such that a shelf on a support in a standard position can be plugged into the contacts, or the contacts may be continuous, for example located in slots in the back or sides of the cabinet. For this latter embodiment, the shelf may contain a pair of contacts that are inserted into the slot, making contact with a conductive surface connected to the household current, somewhat similar to the interconnect systems used for well-known track lighting systems.

The electrical interconnect schemes disclosed here may be further extended to allow for the installation of lights inside cabinets at positions other than on the shelves. For example, by providing appropriately placed and configured mating electrical contacts in the cabinet and on the light sources, flat-panel OLED light sources may be positioned on the inside top, bottom, or side rigid surfaces of a cabinet.

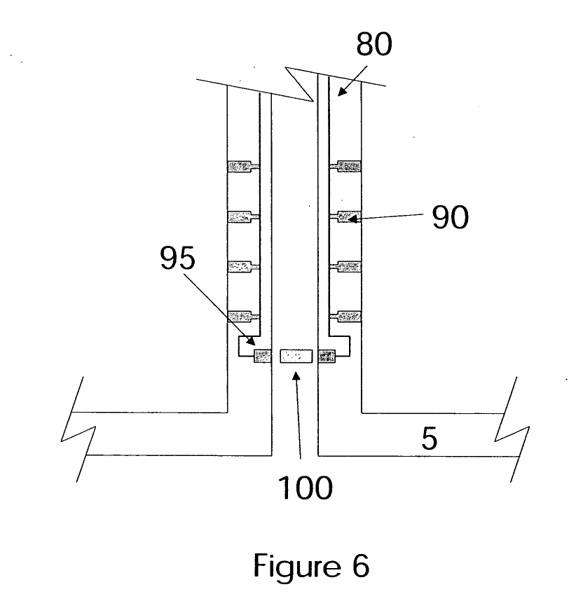

Commercially produced cabinets are typically made in a wide variety of stock sizes from which the home or office designer selects a mix of units that are assembled in place in a kitchen, closet, office, or other location. In order to facilitate on-site assembly, cabinets may contain features to simplify daisy chaining the power from one cabinet to another. FIG. 6 demonstrates one such system. Each cabinet 5 contains one or more connector sockets 95 which align with a corresponding socket on the adjacent cabinet. A connector plug 100 is inserted into the connector sockets of adjacent cabinets to transmit power from one cabinet to the next. Although shown as a simple hole and plug system, there are many alternative known electrical contact means which may be used to provide inter-cabinet contact, including means that allow for limited misalignment between adjacent cabinets, or for small movements as the cabinets are shimmed and fastened in place or for simple electrical connections using conventional wiring techniques.

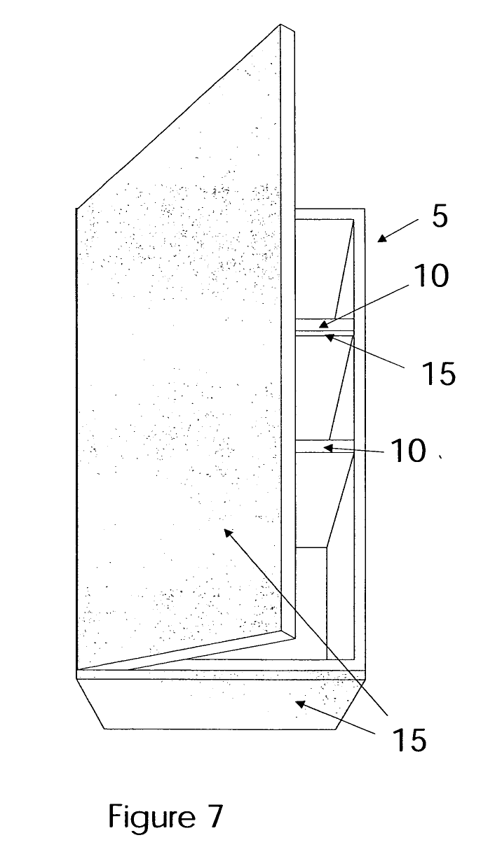

In addition to providing interior light, the present invention enables cabinet systems that provide light outside the cabinet, either for decorative or functional purposes, or a combination of the two. Referring to FIG. 7, a cabinet 5 is provided with flat-panel light sources on the bottom surface and on the door. Use of a removably affixed flat-panel light source on the bottom surface may be particularly helpful when the cabinet is mounted above a counter or other work surface, such as is commonly found in kitchen cabinets. The light on the door may be purely decorative, or in cases where the cabinets are used in dimly lit environments, such as home theaters, a dimly lit door may identify the location of key controls as well as provide guidance towards the cabinet in the dim room. The internal wiring system described above may be easily extended to power panels on doors and the outside of the cabinet. In the case of doors, power may be transmitted to hinges, which in turn interface directly with the cabinet wiring system. Although lights are only shown on the outside of the door and bottom of the cabinet, any surface of the cabinet may contain a light and any of these surfaces may be integrated with the internal wiring system. Although shown covering the entire surface, the flat-panel light source may cover only a portion of the surface if desired. Similar to where the flat-panel light source may serve as a shelf according to a previously described embodiment of the present invention, the flat-panel light source may also serve as the door itself, or as another rigid surface of a cabinet.

In yet another embodiment, the flat-panel light sources of the present invention may be provided within a drawer. In this embodiment, the inside of the front of the drawer, the sides, or a drawer divider may all incorporate a flat-panel light or may themselves be a flat-panel light. In this configuration, power may be supplied through coiled wires that may be extended when the drawer is open and coiled when the drawer is closed. Other means well known in the art for providing power to a movable fixture may also be employed.

The present invention may incorporate switching means to turn the flat-panel lighting sources on and off. Door-activated switches that use a compressed plunger to switch power may be used, as may motion sensors or touch sensors. Switches may be integrated into the flat-panel light source and the light sources used selectively by an operator. Light sources may be activated by remote control devices as known in the art. Power switches that use ambient light detectors may also be employed, particularly for applications in which the flat-panel light source is not enclosed. Switches may be mechanically or sonically actuated by an operator.

Flat-panel area illumination light sources, especially those produced using OLED technology, can be easily produced in different colors, patterns, or shapes. This design flexibility can be utilized to increase the versatility of the flat-panel lights employed in this invention. Shelf lights may be designed to have different colored regions or change colors over time to produce special lighting effects. Lights affixed to doors or cabinet sides may contain decorative patterns or dynamic color and intensity effects.

Flat panel light sources such as those useful in the present invention may also be combined with an optical film in order to better direct the light produced by the light source. Such optical films are well known in the art and typically comprise a thin sheet of polymer material in which lenslet or prism-like features are provided to capture and better direct light in a desired direction. For example, in the present invention, an optical film positioned over the top of a flat panel light source which had been mounted on the under side of a shelf, would be expected to increase the amount of light directed downwards to an underlying shelf. Such an arrangement would provide a greater intensity of illumination for objects located on the underlying shelf. An example of an OLED flat panel light source combined with a light-directing lenslet array along with various means of providing the lenslet array is disclosed in US 2004/0042198 A1, by Cok, the disclosure of which is hereby incorporated by reference.

OLED light sources are not affected by low temperatures as are fluorescent lamps, which are hard to operate at temperatures common in cold storage environments. This makes OLED flat panel light sources especially appropriate for use in cold environments, such as where the enclosed space is actively cooled (e.g., home freezers) as well as in the deep chill of outer space. OLED light sources may also be produced such that they can operate robustly under high pressure as might be experienced in a hyperbaric chamber or autoclave, making them especially appropriate for providing illumination in enclosures designed to be pressurized above normal atmospheric pressure. Such high-pressure tolerant light sources may be created using conventional concepts within the OLED art. For example, OLED light sources can be made high-pressure tolerant by filling any cavity within the display, especially any cavity between a substrate and a cover, with a material such as a polymer. Techniques for providing a polymer-filled cavity within an OLED between the cover and the substrate are known.

In addition to tolerance to low temperatures and to high pressure, such flat-panel light sources are also low-pressure tolerant and may be employed in applications requiring a low-pressure or vacuum environment. Thus flat-panel light sources may be employed in enclosed spaces by means similar to the ones disclosed herein of vehicles such as submarines or even spacecraft which may be unheated or inadequately insulated, or not fully pressurized, or subject to repeated pressurization and depressurization cycles, such as in airlocks. These light sources may even be used on the exterior of spacecraft and provide illumination for personnel making extra-vehicular excursions for exploration of problems and repairs.

Although OLED technology is particularly well suited to producing flat-panel area illumination lights suitable for use in the invention, other area illumination light source technologies may be used as well. Flat electro-luminescent panels, e.g., while not nearly as bright, already can be produced quite inexpensively.

The invention has been described in detail with particular reference to certain preferred embodiments thereof, but it will be understood that variations and modifications can be effected within the spirit and scope of the invention.

### Parts List

5 Cabinet
10 Shelf
15 Flat-panel light source
25 Cathode
30 Electron injection layer
35 Emitter layer
40 Hole injection layer
45 Anode
50 Substrate
51 Cover
60 Hole
65 Shelf support
70 Energized shelf support
75 support contact
80 Conductor
85 Shelf contact
90 Energized hole
95 Connector socket
100 Connector plug

What is claimed is:

1. An illuminated storage system comprising one or more rigid surfaces defining an enclosed volume; two or more conductors attached to one or more of the rigid surfaces; one or more solid-state flat panel area illumination light sources, each light source having electrical contacts; and means for making contact between a pair of the conductors attached to the rigid surfaces and the electrical contacts of the flat-panel light sources.

2. An illuminated storage system according to claim 1, wherein the solid-state flat panel area illumination light source comprises i) a substrate, ii) an organic light emitting diode (OLED) layer deposited upon the substrate, the organic light emitting diode layer including first and second electrodes for providing electrical power to the OLED layer, iii) an encapsulating cover covering the OLED layer, and iv) first and second conductors located on the substrate and electrically connected to the first and second electrodes, and extending beyond the encapsulating cover for making electrical contact to the first and second electrodes by an external power source.

3. An illuminated storage system claimed in claim 2, wherein the first and second conductors are located at one or more edges of the substrate.

4. An illuminated storage system claimed in claim 3, wherein the first and second conductors are located at opposite edges of the substrate.

5. An illuminated storage system claimed in claim 2, wherein the light sources emit light from one side of the substrate and the first and second conductors are located on an opposite side of the substrate.

6. An illuminated storage system claimed in claim 2, wherein the substrate is rigid and planar.

7. An illuminated storage system according to claim 1, wherein the one or more flat-panel light sources are removably affixed to one or more of the rigid surfaces defining the enclosed volume.

8. An illuminated storage system according to claim 1, further comprising one or more shelves within the enclosed volume, and wherein the one or more flat-panel light sources are removably affixed to one or more shelves.

9. An illuminated storage system according to claim 1, wherein one or more flat-panel light sources function as one or more removable shelves positioned within the enclosed volume.

10. The illuminated storage system of claim 9, wherein the flat-panel light source includes a substrate and the substrate is greater than or equal to 5 mm thick.

11. The illuminated storage system of claim 1, comprising two or more rigid surfaces containing a plurality of holes arrayed such that a support pin may be placed in the hole making continuous electrical contact between the conductors and electrical contacts on a removable shelf.

12. The illuminated storage system of claim 11, where the support pin is electrically insulated.

13. The illuminated storage system of claim 1, where the flat-panel light source is affixed to the exterior of the defined volume.

14. The illuminated storage system of claim 1, where the flat-panel light source is affixed to the exterior of a door which acts a rigid surface defining the volume.

15. The illuminated storage system of claim 1, where the flat-panel light source also functions as a door which acts as a rigid surface defining the volume.

16. The illuminated storage system of claim 1, further comprising means for transmitting power to an adjacent illuminated storage system.

17. The illuminated storage system of claim 1, where a rigid surface contains more than one flat-panel light source.

18. The illuminated storage system of claim 1, where the flat-panel light source is comprised of one or more electro-luminescent elements.

19. The illuminated storage system of claim 1, further comprised of a means to dynamically control the color and intensity of one or more of the flat-panel light sources.

20. The illuminated storage system of claim 1, where the enclosed volume is actively cooled.

21. The illuminated storage system of claim 1, where the storage system is unheated and is in an environment at temperatures below room temperature.

22. The illuminated storage system of claim 1, where the enclosed volume can be maintained at a pressure in excess of 1 atmosphere.

23. The illuminated storage system of claim 1, where the enclosed volume can be maintained at a pressure less than 1 atmosphere.

24. The illuminated storage system of claim 1, where the flatpanel light source is affixed to an interior surface of the enclosed volume.

25. The illuminated storage system of claim 1, where the flat-panel light source is affixed to an exterior surface of the enclosed volume.

26. The illuminated storage system of claim 1, where the enclosed volume is a drawer and the flat-panel light source is removably attached to one or more of the inside drawer front, side, back, bottom, or a drawer divider.

27. The illuminated storage system of claim 1, further comprising a switch.

28. The illuminated storage system of claim 27, wherein the switch is mounted on a rigid surface.

29. The illuminated storage system of claim 27, wherein the switch is mounted on the flat-panel light source.

30. The illuminated storage system of claim 27, wherein the switch is mechanically or sonically actuated.

31. The illuminated storage system of claim 27, wherein the switch is actuated by touch.

32. The illuminated storage system of claim 1 wherein the flat-panel light source is an OLED light source.

33. The illuminated storage system of claim 1 wherein the flat-panel illumination source further comprises a light directing optical film disposed over the source.
